(19) United States
(12) Patent Application Publication
(10) Pub. No.: US 2011/0070001 A1
(43) Pub. Date: Mar. 24, 2011

(54) Steering Mechanism for Belt Unit

(75) Inventor: Takeru Morofushi, Shizuoka (JP)

(73) Assignees: Kabushiki Kaisha Toshiba, Tokyo (JP); Toshiba Tec Kabushiki Kaisha, Tokyo (JP)

(21) Appl. No.: 12/873,216

(22) Filed: Aug. 31, 2010

Related U.S. Application Data
(60) Provisional application No. 61/244,747, filed on Sep. 22, 2009.

(51) Int. Cl. G03G 15/14; B65G 39/16

(52) U.S. Cl. 399/313; 198/806

(57) ABSTRACT

A belt unit includes a belt that is rotated, a belt comprising a rib formed on an inner periphery thereof, a plurality of supporting rollers configured to support the belt rotatably, a steering roller configured to contact with the inner periphery of the belt, a sensing roller configured to rotate in contact with the rib and a transmission configured to transmit a rotation of the sensing roller to the steering roller and configured to change an angle of the steering roller with respect to an axis of rotation of the belt.

### CROSS-REFERENCE TO RELATED APPLICATION

This application is based upon and claims the benefit of priority from provisional U.S. Application 61/244,747 filed on Sep. 22, 2009, the entire contents of which are incorporated herein by reference.

### FIELD

Embodiments described herein relate generally to a belt unit configured to regulate an endless belt mounted in copying machines, printers, or multi function peripherals so as not to meander during travel.

### BACKGROUND

A belt unit mounted in a Multi Function Peripheral (MFP) or a printer needs to regulate a belt deviation. In order to regulate the belt deviation, there is a unit configured to sense the belt deviation and incline a steering roller.

In the belt unit having the steering roller, if the structure for sensing the belt deviation becomes complex, cost reduction of the belt unit may be hindered.

Therefore, in the field of the belt unit having the steering roller, development of a belt unit having a simplified structure for sensing the belt deviation and being capable of reliably regulating the belt deviation even at a low cost is desired.

### BRIEF DESCRIPTION OF THE DRAWINGS

FIG. 1 is a schematic drawing showing a configuration of a principal portion of a transfer belt unit and a printer unit of an image forming apparatus;

FIG. 2 is a schematic perspective view showing the transfer belt unit;

FIG. 3 is a schematic plan view showing a self steering mechanism;

FIG. 4 is a schematic perspective view showing the self steering mechanism in a state in which a slide panel and a steering unit are separated;

FIG. 5 is a schematic plan view showing the slide panel;

FIG. 6 is a schematic plan view snowing the steering unit;

FIG. 7 is a schematic explanatory drawing showing a layout of a transfer belt and a sensing roller;

FIG. 8 is a schematic perspective view showing a first link;

FIG. 9 is a schematic plan view showing the first link;

FIG. 10 is a schematic explanatory drawing showing a second link;

FIG. 11 is a schematic explanatory drawing showing a drive of a second gear unit;

FIG. 12 is a schematic explanatory drawing showing a correction of the direction of travel of the transfer belt being deviated toward the front;

FIG. 13 is a schematic explanatory drawing showing a drive of a first gear unit;

FIG. 14 is a schematic explanatory drawing showing a correction of the direction of travel of the transfer belt being deviated toward the rear; and

FIG. 15 is a schematic plan view showing a self steering mechanism of a modification;

### DETAILED DESCRIPTION

According to an embodiment, a belt unit includes a belt that is rotated, a belt comprising a rib formed on an inner periphery thereof, a plurality of supporting rollers configured to support the belt rotatably, a steering roller configured to contact with the inner periphery of the belt, a sensing roller configured to rotate in contact with the rib and a transmission configured to transmit a rotation of the sensing roller to the steering roller and configured to change an angle of the steering roller with respect to an axis of rotation of the belt.

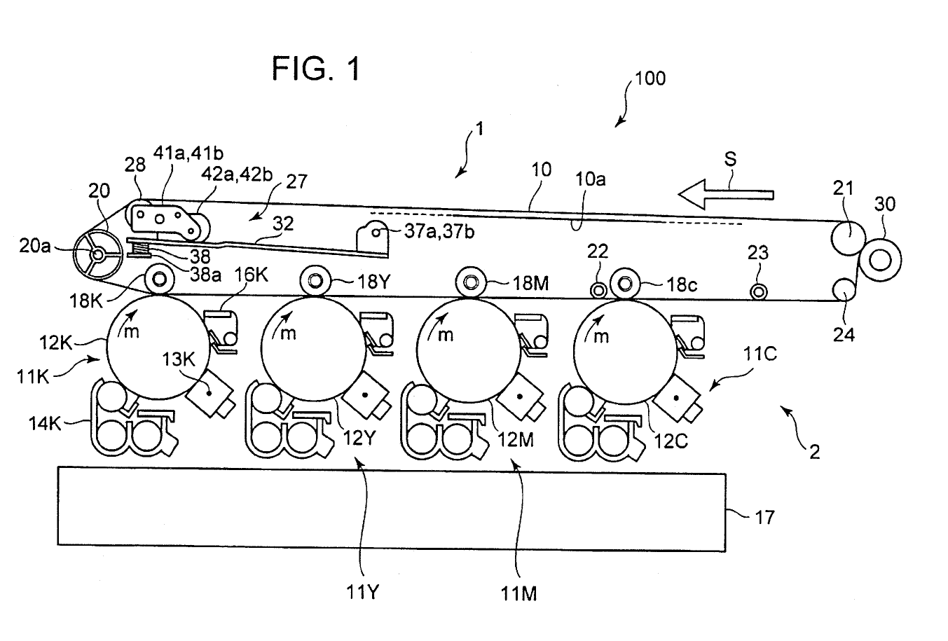

The embodiment will be described below. As shown in FIG. 1, a printer unit 2 is provided under a transfer belt unit 1 of an image forming apparatus 100. The printer unit 2 has image forming stations 11K, 11Y, 11M, and 11C for respective colors of black (K), yellow (Y), magenta (M) and cyan (C) arranged in tandem along a transfer belt 10 of the transfer belt unit 1. The printer unit 2 has a laser exposure unit 17.

The laser exposure unit 17 is configured to irradiate photoconductive drums 12K, 12Y, 12M, and 12C as image carriers of the image forming stations 11K, 11Y, 11M, and 11C for the respective colors with laser beams corresponding to image information.

The image forming station 11K for black (K) of the printer unit 2 has a charger 13K, a developing unit 14K, a transfer roller 18K, and a cleaner 16K around the photoconductive drum 12K rotating in the direction indicated by an arrow m. Configurations of the image forming stations 11Y, 11M, 11C for yellow (Y), magenta (M) and cyan (C) are the same as the image forming station 11K for black (K).

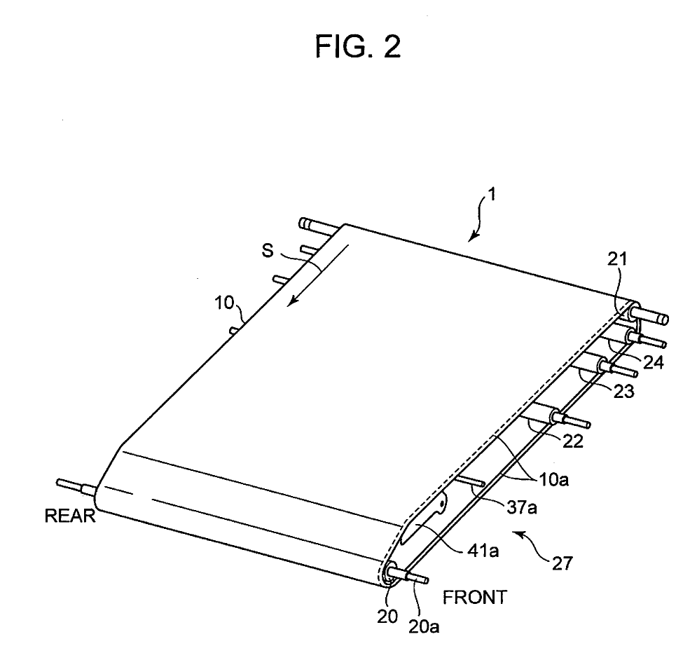

The transfer belt 10 has a rib 10a on one side in the width direction, for example, on the inner periphery of the front side. The rib 10a is formed by bonding a thin cord-shaped rubber on the inner periphery of the transfer belt 10. The rib may be provided on both sides of the transfer belt 10 in the width direction. The plurality of the supporting rollers shown in FIG. 2, namely, a drive roller 20, a driven roller 21, and first to third tension rollers 22 to 24 support the transfer belt 10. A steering roller 28 contacts the inner periphery of the transfer belt 10. An axis of rotation γ of the transfer belt parallels to a shaft 20a of the drive roller 20.

A secondary transfer roller 30 opposes the transfer belt 10 at a secondary transfer position. At the secondary transfer position, a toner image on the transfer belt 10 is secondarily transferred to a sheet P by a transfer bias supplied to the secondary transfer roller 30. The structure of the transfer belt unit 1 is not limited thereto.

When the image forming apparatus 100 starts a printing, for example, at the image forming station 11K for black (K), the photoconductive drum 12K rotates in the direction indicated by the arrow m. In association with the rotation of the photoconductive drum 12K, the charger 13K charges the photoconductive drum 12K uniformly. The laser exposure unit 17 irradiates the photoconductive drum 12K with an exposure light corresponding to the image information in black (K) and forms an electrostatic latent image on the photoconductive drum 12K. The developing unit 14K then forms a toner image on the photoconductive drum 12K. The transfer roller 18K primarily transfers the toner image on the photoconductive drum 12K onto the transfer belt 10 rotating in the direction indicated by an arrow s. After the primary transfer, the cleaner 16K cleans residual toner on the photoconductive drum 12K.

The image forming stations 11Y, 11M, 11C for yellow (Y), magenta (M) and cyan (C) form toner images on the photoconductive drums 12Y, 12M, and 12C in the same manner as the image forming station 11K for black (K). The respective toner images in yellow (Y), magenta (M), cyan (C) on the photoconductive drums 12Y, 12M, and 12C are multiply transferred to the transfer belt 10 in sequence to form a full color toner image.

The full color toner image on the transfer belt 10 is then secondarily transferred from the transfer belt 10 to the sheet P by the secondary transfer roller 30. The sheet P reaches the secondary transfer position synchronously with the full color toner image on the transfer belt 10 reaching the secondary transfer position. The sheet P having the full color toner image is subjected to fixation, and then the image forming apparatus 100 finishes the printing.

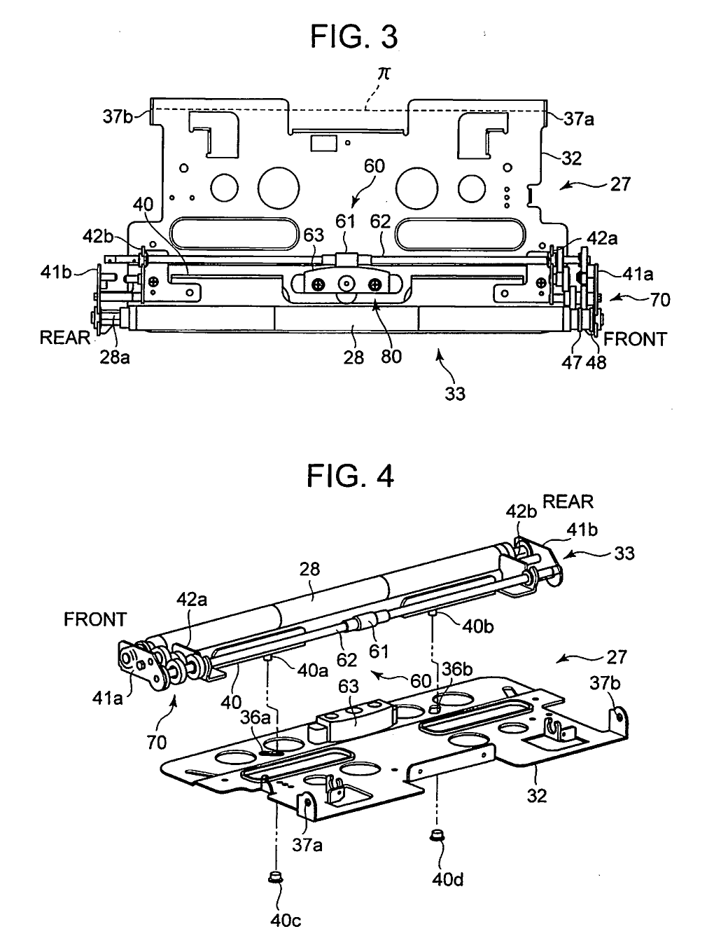

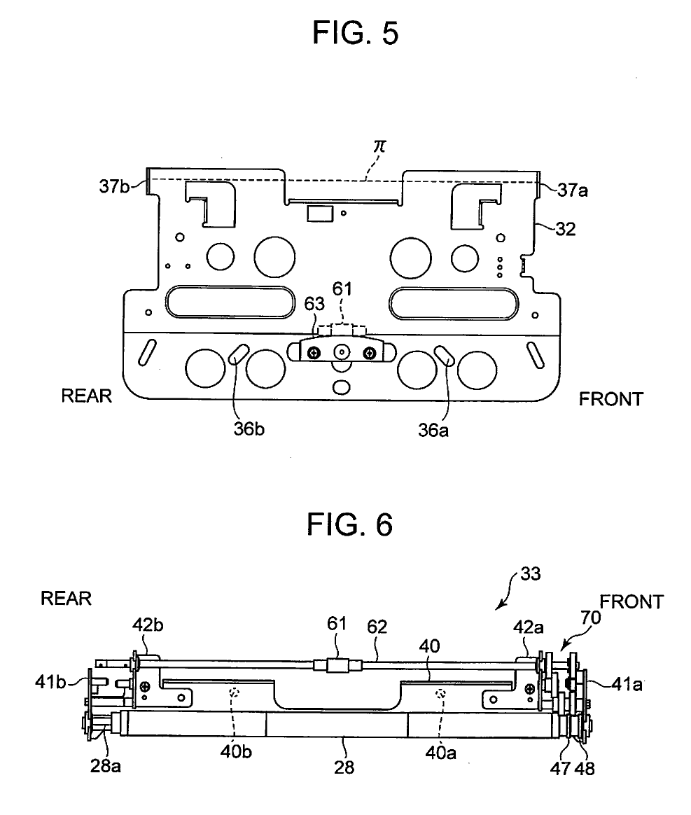

The transfer belt 10 has a self steering mechanism 27 on the inner periphery thereof. As shown in FIG. 3 to FIG. 6, the self steering mechanism 27 has a slide panel 32 and a steering unit 33 provided with the steering roller 28. The slide panel 32 supports and fixes a circular arc shaped fixed gear 63. The slide panel 32 has slits 36a and 36b for rotating the steering unit 33. The slide panel 32 rotates about supporting points 37a and 37b with respect to a main body of the image forming apparatus 100. An axial line π passing through the supporting points 37a and 37b parallels to the shaft 20a of the drive roller 20. As shown in FIG. 1, a spring 38 as a pusher is provided between the slide panel 32 and a regulating panel 38a. The spring 38 pushes the slide panel 32 upward about the supporting points 37a and 37b. By pushing the slide panel 32 upward, the steering roller 28 provides a tension to the transfer belt 10.

The steering unit 33 has a steering supporting panel 40 as a steering supporter. The steering supporting panel 40 has side frames 41a and 41b, and inner frames 42a and 42b. The side frames 41a and 41b support the steering roller 28. The inner frames 42a and 42b support a worm shaft 62. A shaft 28a of the steering roller 28 parallels to the worm shaft 62.

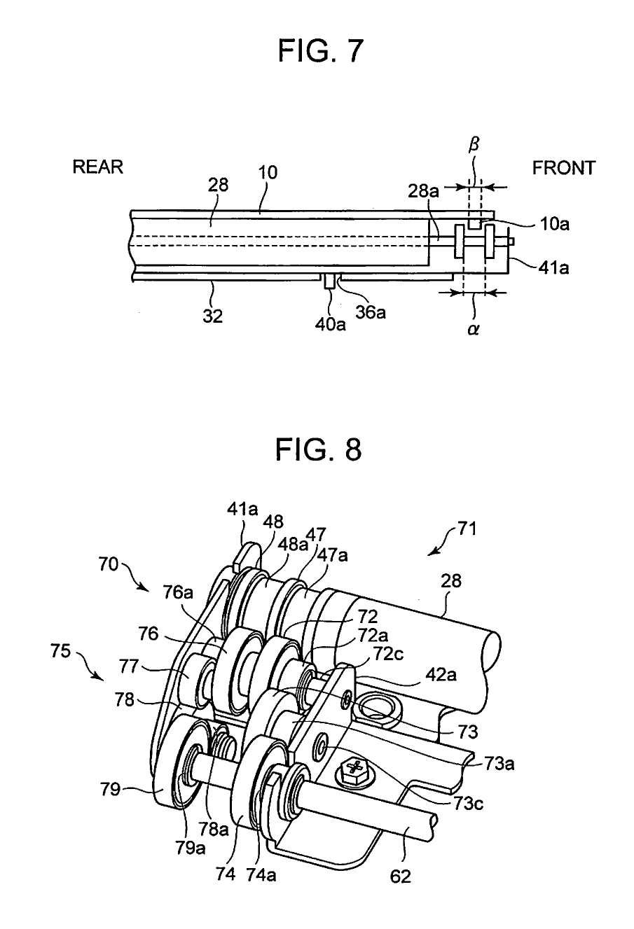

The shaft 28a of the steering roller 28 supports a first sensing roller 47 and a second sensing roller 48 as sensing rollers, for example, on the front side. Diameters of the first sensing roller 47 and the second sensing roller 48 are smaller than the diameter of the steering roller 28. As shown in FIG. 7, the first sensing roller 47 and the second sensing roller 48 are apart from the inner periphery of the transfer belt 10. The rib 10a is located in a gap a between the first sensing roller 47 and the second sensing roller 48. The gap α is larger than a width □ of the rib 10a. When the transfer belt 10 is not deviated and the transfer belt is at a normal position, the rib 10a comes apart from the first sensing roller 47 and the second sensing roller 48. The first sensing roller 47 has a first gear 47a. The second sensing roller 48 has a fifth gear 48a.

A first link 70 and a second link 80 as transmissions are provided from the first sensing roller 47 or the second sensing roller 48 to the steering supporting panel 40. The first link 70 transmits the rotation of the first sensing roller 47 or the second sensing roller 48 to a worm gear 60. The second link 80 transmits the rotation of the first sensing roller 47 and the second sensing roller 48 from the worm gear 60 to the steering roller 28 via the steering supporting panel 40.

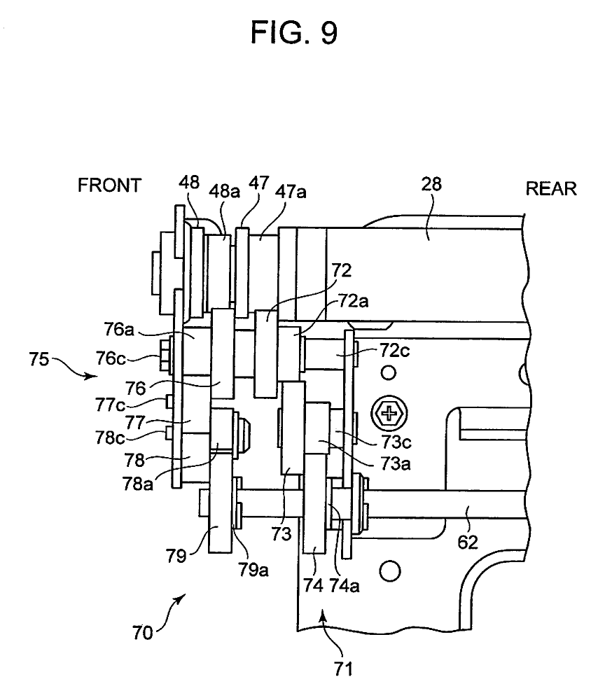

The worm gear 60 has a worm 61, the worm shaft 62 configured to coaxially support the worm 61, and the fixed gear 63 engaging the worm 61. As shown in FIG. 8 and FIG. 9, the first link 70 has a first gear unit 71 configured to transmit the rotation of the first sensing roller 47 to the worm shaft 62. The first link 70 has a second gear unit 75 configured to transmit the rotation of the second sensing roller 48 to the worm shaft 62.

The first gear unit 71 has a second gear 72 provided on a shaft 72c in parallels to the shaft 28a and engaging the first gear 47a of the first sensing roller 47, a second deceleration gear 72a coaxial with the second gear 72, a third gear 73 provided on a shaft 73c parallels to the shaft 28a and engaging the second deceleration gear 72a, a third deceleration gear 73a coaxial with the third gear 73, and a fourth gear 74 coaxial with the worm shaft 62 and engaging the third deceleration gear 73a. The fourth gear 74 has a first one-way clutch 74a and transmits only a rightward rotation viewed from the front to the worm shaft 62.

The second gear unit 75 has a sixth gear 76 provided on a shaft 76c parallels to the shaft 28a and engaging the fifth gear 48a of the second sensing roller 48, a sixth deceleration gear 76a coaxial with the sixth gear 76, a seventh gear 77 provided on a shaft 77c parallels to the shaft 28a and engaging the sixth deceleration gear 76a, an eighth gear 78 provided on a shaft 78c parallels to the shaft 28a and engaging the seventh gear 77, an eighth deceleration gear 78a coaxial with the eighth gear 78, and a ninth gear 79 coaxial with the worm shaft 62 and engaging the eighth deceleration gear 78a. The ninth gear 79 has a second one-way clutch 79a and transmits only a leftward rotation viewed from the front to the worm shaft 62.

The second link 80 has the slide panel 32 having the slits 36a and 36b, the worm shaft 62, the worm 61 configured to rotate with the rotation of the worm shaft 62, the fixed gear 63 engaging the worm 61, and the steering supporting panel 40 configured to slide on the slide panel 32 integrally with the worm shaft 62. The slits 36a and 36b of the slide panel 32 are configured to guide pins 40a and 40b of the steering supporting panel 40. The pins 40a and 40b are provided with pin stoppers 40c and 40d.

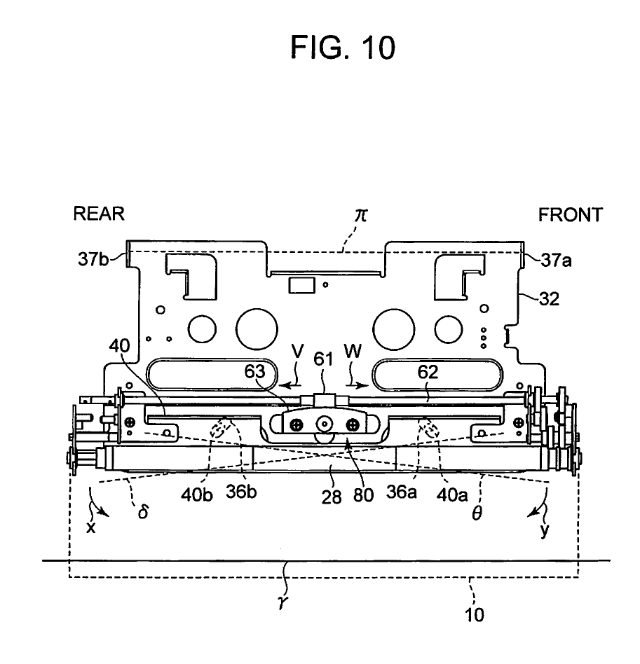

In the second link 80, as shown in FIG. 10, if the worm shaft 62 is rotated rightward viewed from the front, the worm 61 engages the fixed gear 63, and advances in the direction indicated by an arrow v, which is parallel to the axial line π passing through the supporting points 37a and 37b of the slide panel 32. The worm 61 moves linearly in the rear direction of the axial line π passing through the supporting points 37a and 37b of the slide panel 32 along the fixed gear 63 and moves in the direction of rotation with respect to the axial line π passing through the supporting points 37a and 37b of the slide panel 32.

With the advancement of the worm 61 in the direction indicated by the arrow v, the pins 40a and 40b of the steering supporting panel 40 which supports the worm shaft 62 slide in the slits 36a and 36b, and move the steering supporting panel 40 toward the rear side while rotating the steering supporting panel 40 in the direction indicated by an arrow x as a first direction. The steering roller 28 rotates together with the steering supporting panel 40 in the direction indicated by the arrow x, and moves toward the rear side. The axis of rotation of the steering roller 28 inclines respect to the axial line π passing through the supporting points 37a and 37b of the slide panel 32. The steering roller 28 changes an angle respect to the axial line π passing through the supporting points 37a and 37b and inclines in the direction indicated by a broken line δ.

If the worm shaft 62 is rotated leftward viewed from the front, the worm 61 engages the fixed gear 63, and advances in the direction indicated by an arrow w, which is parallel to the axial line π passing through the supporting points 37a and 37b of the slide panel 32. The worm 61 moves linearly in the front direction of the axial line π passing through the supporting points 37a and 37b of the slide panel 32 along the fixed gear 63, and moves in the direction of rotation with respect to the axial line π passing through the supporting points 37a and 37b of the slide panel 32.

With the advancement of the worm 61 in the direction indicated by the arrow w, the pins 40a and 40b of the steering supporting panel 40 which supports the worm shaft 62 slide in the slits 36a and 36b, and move the steering supporting panel 40 toward the front side while rotating the steering supporting panel 40 in the direction indicated by an arrow y as a second direction. The steering roller 28 rotates together with the steering supporting panel 40 in the direction indicated by the arrow y, and moves toward the front side. The axis of rotation of the steering roller 28 inclines respect to the axial line π passing through the supporting points 37a and 37b of the slide panel 32. The steering roller 28 changes the angle respect to the axial line π passing through the supporting points 37a and 37b and inclines in the direction indicated by a broken line θ.

The steering roller 28 rotates on a plane parallel to a plane including the axial line π passing through the supporting points 37a and 37b and inclines respect to the axial line π. During the rotation of the worm shaft 62, the steering roller 28 slides in the plane parallel to the plane including the axial line π in the direction indicated by the arrow v and rotates in the direction indicated by the arrow x or, alternatively, slides in the plane parallel to the plane including the axial line π in the direction indicated by the arrow w and rotates in the direction indicated by the arrow y. The rotation of the steering roller 28 in the plane parallel to the plane including the axial line π does not have an axis of rotation at a constant position. The steering roller 28 rotates in the plane parallel to the plane including the axial line π about the pins 40a and 40b of the steering supporting panel 40 sliding in the slits 36a and 36b as supporting shafts.

Subsequently, an operation of the self steering mechanism 27 will be described. During printing, if the transfer belt 10 does not meander, and rotates and travels at the normal position, the rib 10a of the transfer belt 10 moves apart from both the first sensing roller 47 and the second sensing roller 48. If the transfer belt 10 rotates and travels at the normal position, the self steering mechanism 27 is not activated. If the transfer belt 10 meanders during printing and is deviated toward the front side or the rear side, the self steering mechanism 27 senses the deviation of the transfer belt 10, inclines the shaft 28a of the steering roller 28 respect to the axial line π passing through the supporting points 37a and 37b, and corrects the direction of travel of the transfer belt 10.

(Meandering on the Front Side)

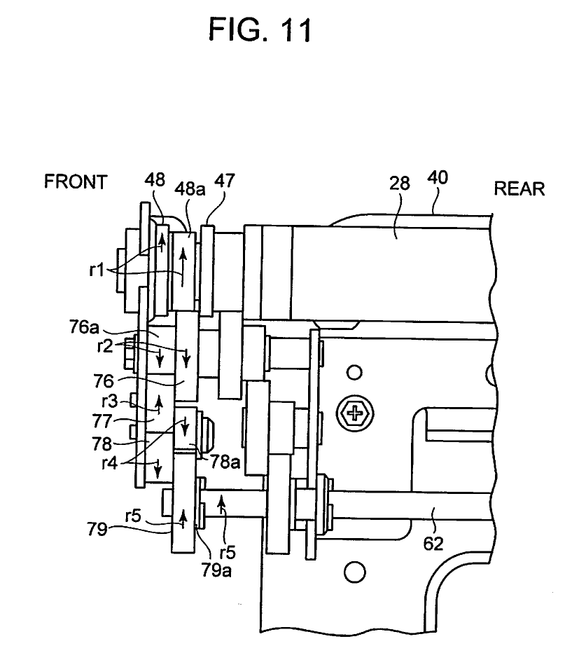

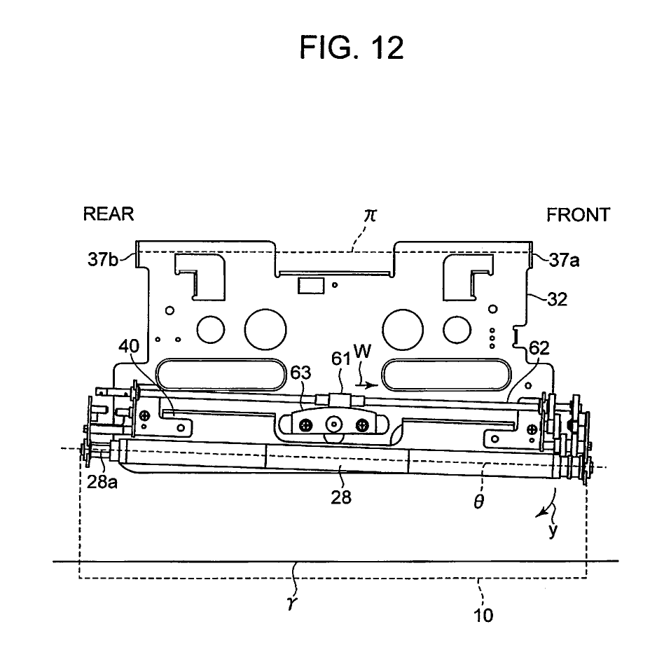

Referring now to FIG. 11 and FIG. 12, for example, correction of the direction of travel of the transfer belt 10 when the transfer belt 10 meanders on the front side will be described. The directions of rotation of the respective gears described here are the directions of rotation when viewed from the front side. (1) If the transfer belt 10 traveling in the direction indicated by the arrow s is deviated toward the front side, a side surface of the rib 10a on the front side as a second side surface, contacts with the second sensing roller 48 and rotates the second sensing roller 48 and the fifth gear 48a leftward (r1). (2) The sixth gear 76 engaging the fifth gear 48a and the sixth deceleration gear 76a rotate rightward (r2). (3) The seventh gear 77 engaging the sixth deceleration gear 76a rotates leftward (r3). (4) The eighth gear 78 engaging the seventh gear 77 and the eighth deceleration gear 78a rotate rightward (r4).

(5) The ninth gear 79 engaging the eighth deceleration gear 78a rotates leftward (r5) and transmits the leftward rotation (r5) to the worm shaft 62. (6) If the worm shaft 62 rotates leftward, the worm 61 advances along the fixed gear 63 in the direction indicated by the arrow w. (7) The steering supporting panel 40 is maintained at a position parallel to the slide panel 32 having the supporting points 37a and 37b via the worm shaft supporting the worm 61, rotates in the direction indicated by the arrow y along the slits 36a and 36b about the pins 40a and 40b as supporting shafts, and moves toward the front. The steering supporting panel 40 rotates in a plane of the slide panel 32. (8) The steering roller 28 rotating integrally with the steering supporting panel 40 changes the angle with respect to the axial line π passing through the supporting points 37a and 37b in a plane parallel to the slide panel 32, and inclines as indicated by the broken line θ. (9) The inclined steering roller 28 generates a force to transport the transfer belt 10 in the direction vertical to the broken line θ. (10) The transfer belt 10 slides toward the rear as a fourth direction, by the transporting force in the direction vertical to the broken line θ by the steering roller 28, and corrects the direction of travel.

If the steering roller 28 is inclined and the direction of travel of the transfer belt 10 is corrected to the normal direction, the rib 10a of the transfer belt 10 moves apart from the second sensing roller 48. The second sensing roller 48 stops rotating.

(Meandering on the Rear Side)

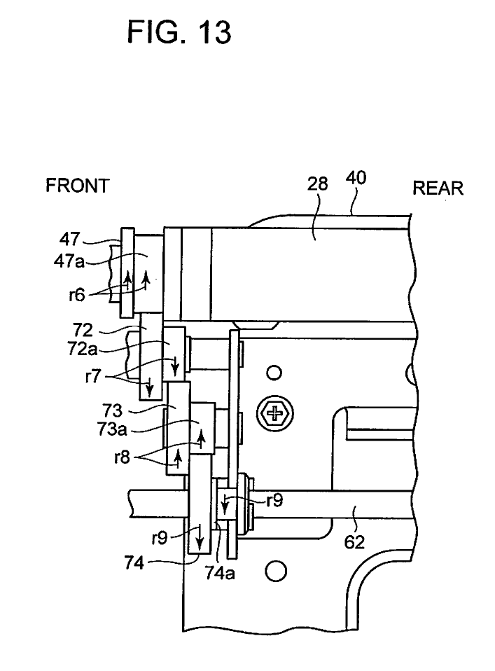

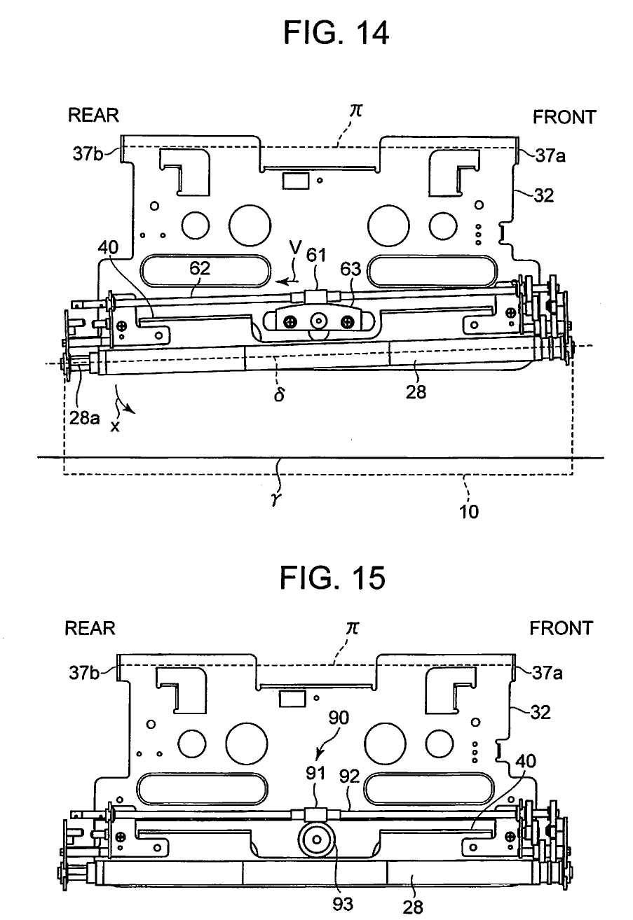

Referring now to FIG. 13 and FIG. 14, for example, the correction of the direction of travel of the transfer belt 10 when the transfer belt 10 meanders on the rear side will be described. The directions of rotation of the respective gears described here are the directions of rotation when viewed from the front side. (11) If the transfer belt 10 traveling in the direction indicated by the arrow s is deviated toward the rear side, a side surface of the rib 10a on the rear side as a first side surface, contacts with the first sensing roller 47 and rotates the first sensing roller 47 and the first gear 47a leftward (r6). (12) The second gear 72 engaging the first gear 47a and the second deceleration gear 72a rotate rightward (r7). (13) The third gear 73 engaging the second deceleration gear 72a and the third deceleration gear 73a rotate leftward (r8). (14) The fourth gear 74 engaging the third deceleration gear 73a rotates rightward (r9) and transmits the rightward rotation to the worm shaft 62.

(15) If the worm shaft 62 rotates rightward, the worm 61 advances along the fixed gear 63 in the direction indicated by the arrow v. (16) The steering supporting panel 40 is maintained at a position parallel to the slide panel 32 having the supporting points 37a and 37b via the worm shaft 62 supporting the worm 61, rotates in the direction indicated by the arrow x along the slits 36a and 36b about the pins 40a and 40b as supporting shafts, and moves toward the rear. The steering supporting panel 40 rotates in the plane of the slide panel 32. (17) The steering roller 28 rotating integrally with the steering supporting panel 40 changes the angle respect to the axial line π passing through the supporting points 37a and 37b in the plane parallel to the slide panel 32, and inclines as indicated by the broken line δ. (18) The inclined steering roller 28 generates a force to transport the transfer belt 10 in the direction vertical to the broken line δ. (19) The transfer belt 10 slides toward the front as a third direction, by the transporting force in the direction vertical to the broken line δ by the steering roller 28, and corrects the direction of travel.

If the steering roller 28 is inclined and the direction of travel of the transfer belt 10 is corrected to the normal direction, the rib 10a of the transfer belt 10 moves apart from the first sensing roller 47. The first sensing roller 47 stops rotating.

The angle of inclination of the steering roller 28 for correcting the direction of travel of the transfer belt 10 to the normal direction is, for example, set to ±3° at maximum. If the tension of the transfer belt 10 is varied during the travel of the transfer belt 10, the spring 38 swings the slide panel 32 about the supporting points 37a and 37b on the side of the steering roller 28′ to provide an adequate tension to the transfer belt 10. The steering roller 28 is contacted with the transfer belt 10 with the adequate tension, so that sensing of the deviation of the transfer belt 10 by the first sensing roller 47 and the second sensing roller 48 is ensured.

According to the embodiment, the rib 10a is contacted with the first sensing roller 47 or the second sensing roller 48 on the front side of the transfer belt 10 to sense the meandering of the transfer belt 10. The rotation of the first sensing roller 47 or the second sensing roller 48 transmits to the steering roller 28 using the worm gear 60. Steering is performed by rotating the steering roller 28 in the plane parallel to the plane including the axial line π passing through the supporting points 37a and 37b in the direction parallel to the axial line π passing through the supporting points 37a and 37b of the slide panel 32 and in the direction of rotation with respect to the axial line π passing through the supporting points 37a and 37b of the slide panel 32, whereby the direction of travel of the transfer belt 10 is corrected.

According to the embodiment, the meandering of the transfer belt 10 can be sensed on the one side of the transfer belt. The transfer belt 10 can be formed into a transfer belt with a one-side rib, and a configuration to transmit driving of the sensing roller to the steering roller can be simplified. The cost and weight of the steering mechanism for reliably correcting the deviation of the transfer belt are reduced.

The fixed gear may simply have a shape which prevents the worm and the fixed gear from being disengaged when the rotating worm moves along the fixed gear. For example, in a modification shown in FIG. 15, a fixed gear 93 of a worm gear 90 is formed into a wheel shape. A worm 91 engaging the fixed gear 93, which is to be fixed to the slide panel 32, moves toward the front side or rear side along the fixed gear 93 during rotation thereof. While rotating the steering supporting panel 40 supporting a worm shaft 92, the worm 91 moves toward the front side or the rear side, rotates the steering roller 28 in the plane parallel to the plane including the axial line π passing through the supporting points 37a and 37b together with the steering supporting panel 40, and inclines the steering supporting panel 40 respect to the axial line π passing through the supporting points 37a and 37b.

While certain embodiments have been described, these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

1. A belt unit comprising:
a belt comprising a rib formed on an inner periphery thereof;
a plurality of supporting rollers configured to support the belt rotatably;
a steering roller configured to contact with the inner periphery of the belt;
a sensing roller configured to rotate in contact with the rib; and
a transmission configured to transmit a rotation of the sensing roller to the steering roller and configured to change an angle of the steering roller with respect to an axis of rotation of the belt.

2. The unit of claim 1, wherein the sensing roller rotates about an axis of the steering roller.

3. The unit of claim 2, wherein the sensing roller comprising a first sensing roller configured to contact with a first side surface of the rib and a second sensing roller configured to contact with a second side surface of the rib.

4. The unit of claim 3, wherein the transmission configured to rotate the steering roller in a first direction with respect to the axis of rotation of the belt by the rotation of the first sensing roller, and to rotate the steering roller in a second direction with respect to the axis of rotation of the belt by the rotation of the second sensing roller.

5. The unit of claim 4, wherein the belt configured to slide in a third direction parallel to the axis of rotation of the belt when the steering roller rotates in the first direction, and to slide in a fourth direction parallel to the axis of rotation of the belt when the steering roller is inclined in the second direction.

6. The unit of claim 1, wherein the transmission comprising a worm gear and a steering supporter configured to support the steering roller, and configured to move the steering roller in the direction parallel to the axis of rotation of the belt and in the direction of rotation with respect to the axis of rotation of the belt by the rotation of the sensing roller.

7. The unit of claim 6, wherein the worm gear comprising a fixed gear, a worm engaging the fixed gear, and a worm shaft in parallel with an axis of the steering roller and configured to coaxially support the worm.

8. The unit of claim 7, wherein the transmission further comprising a slide panel configured to support the fixed gear, and the slide panel supports and slides the steering supporter along a guide.

9. The unit of claim 1, further comprising a pusher configured to push the steering roller toward to the belt.

10. An image forming apparatus comprising:
an image carrier;
an image forming unit configured to form a toner image on the image carrier;
a belt comprising a rib formed on an inner periphery thereof configured to oppose to the image carrier;
a plurality of supporting rollers configured to support the belt rotatably;
a steering roller configured to contact with the inner periphery of the belt;
a sensing roller configured to rotate in contact with the rib; and
a transmission configured to transmit a rotation of the sensing roller to the steering roller and configured to change an angle of the steering roller with respect to an axis of rotation of the belt.

11. The unit of claim 10, wherein the sensing roller rotates about an axis of the steering roller.

12. The unit of claim 11, wherein the sensing roller comprising a first sensing roller configured to contact with a first side surface of the rib and a second sensing roller configured to contact with a second side surface of the rib.

13. The unit of claim 12, wherein the transmission configured to rotate the steering roller in a first direction with respect to the axis of rotation of the belt by the rotation of the first sensing roller, and to rotates the steering roller in a second direction with respect to the axis of rotation of the belt by the rotation of the second sensing roller.

14. The unit of claim 10, wherein the transmission comprising a worm gear and a steering supporter configured to support the steering roller, and configured to move the steering roller in the direction parallel to the axis of rotation of the belt and in the direction of rotation with respect to the axis of rotation of the belt by the rotation of the sensing roller.

15. The unit of claim 14, wherein the worm gear comprising a fixed gear, a worm engaging the fixed gear, and a worm shaft in parallel with an axis of the steering roller and configured to coaxially support the worm.

16. The unit of claim 15, wherein the transmission further comprising a slide panel configured to support the fixed gear, and the slide panel supports and slides the steering supporter along a guide.

17. The unit of claim 10, further comprising a pusher configured to push the steering roller toward to the belt.

18. A belt steering method comprising:
rotating a belt comprising a rib on a side portion of the belt;
rotating a sensing roller provided on the belt on one side in the width direction by contact with the rib; and
moving a steering roller in the direction parallel to an axis of rotation of the belt and the direction to changes an angle respects to the axis of rotation of the belt by the rotation of the sensing roller.

19. The method of claim 18, wherein an axis of the sensing roller and an axis of the steering roller are coaxial.

20. The method of claim 19, further comprising rotating the steering roller in a first direction with respect to the axis of rotation of the belt with contacting the sensing roller to a first side surface of the rib and rotating the steering roller in a second direction with respect to the axis of rotation of the belt with contacting the sensing roller to a second side surface of the rib.
